(19) United States
(12) Patent Application Publication
(10) Pub. No.: US 2006/0133988 A1
(43) Pub. Date: Jun. 22, 2006

(54) Titanium-containing perovskite composite oxide particle, production process thereof and capacitor

(75) Inventors: Tadatoshi Kurozumi, Chiba-shi (JP); Hitoshi Yokouchi, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K.

(21) Appl. No.: 11/312,460

(22) Filed: Dec. 21, 2005

Related U.S. Application Data
(60) Provisional application No. 60/640,256, filed on Jan. 3, 2005.

(30) Foreign Application Priority Data
Dec. 21, 2004 (JP) 2004-369553

(51) Int. Cl. C01G 23/00

(52) U.S. Cl. 423/598

(57) ABSTRACT

A titanium-containing perovskite composite oxide particle represented by the compositional formula: A(TiₓB₍₁₋ₓ₎)_{y}O₃ (provided that x and y each denoting a compositional ratio are 0≦x≦1 and 0.98≦y≦1.02, A is at least one or more element selected from Ca, Sr, Ba, Pb and Mg, and B is at least one or more element selected from Hf and Zr), wherein the specific surface area is from 1 to 100 m²/g, the average primary particle diameter D1 defined by formula (I) is from 10 to 1,000 nm, and the ratio D2/D1 of D1 to the average secondary particle diameter D2 is from 1 to 10:
D1=6/ρS (I) (wherein ρ is a density of the particle and S is a specific surface area).

### CROSS-REFERENCE TO RELATED APPLICATIONS

This application claims priority from Japanese Patent Application No. 2004-369553 filed on Dec. 21, 2004, in the Japan Patent Office, the disclosure of which is incorporated herein by reference in its entirety. This application also claims benefit of Provisional Application No. 60/640,256 filed Jan. 3, 2005, incorporated herein by reference, under 35 U.S.C. § 111(b) pursuant to 35 U.S.C. § 119(e)(1). These priority claims are being made concurrently with the filing of this application.

### TECHNICAL FIELD

The present invention relates to a titanium-containing perovskite composite oxide particle for use in an electronic material such as a dielectric material, piezoelectric material, pyroelectric material, multilayer ceramic capacitor and thin-film material, and a production process thereof.

### BACKGROUND ART

A titanium-containing perovskite composite oxide particle exhibits excellent electric properties such as dielectricity, piezoelectricity and pyroelectricity and, therefore, is being widely used as various electronic materials.

Examples of the usage thereof include, by making use of high dielectricity of the titanium-containing perovskite composite oxide particle, various capacitor materials (including a multilayer ceramic capacitor), a dielectric filter, a dielectric antenna, a dielectric resonator, a dielectric duplexer, a capacitor and a phase shifter, and also include a stacked piezoelectric actuator by utilizing the piezoelectricity of the titanium-containing perovskite composite oxide particle.

For example, barium titanate zirconate represented by the compositional formula: Ba(Ti_{X}Zr_{(1-X)})O₃ exhibits a high dielectric constant at room temperature and is being used as a large-capacitance capacitor material.

Also, lead titanate zirconate represented by the compositional formula: Pb(Ti_{X}Zr₍₁₋ₓ₎)O₃ exhibits a high piezoelectric property at the morphotoropic boundary and is predominating as a piezoelectric material.

As for the method of using the titanium-containing perovskite composite oxide particle in an electronic material, there is a method of mixing a titanium-containing perovskite composite oxide powder with a solvent to form a slurry or a paste, and shaping it into a thin-film product or a porcelain by molding/sintering, sheeting or the like.

In recent years, down-sized, lightweight and high-performance electronic parts are demanded and as a material therefor, it is required to develop a titanium-containing perovskite composite oxide particle having a small particle diameter, a narrow particle size distribution, excellent dispersibility and high crystallinity.

For example, in order to obtain a down-sized, lightweight and high-capacitance multilayer ceramic capacitor, the particle diameter of the titanium-containing perovskite composite oxide particle must be made small to thereby decrease the distance between stacked layers and increase the number of layers stacked. However, in general, when the particle diameter of the titanium-containing perovskite composite oxide particle becomes small, the dielectric constant decreases and on use as a dielectric material, this leads to a small electrostatic capacitance. To solve this problem, a titanium-containing perovskite composite oxide particle exhibiting a high dielectric constant despite a small particle is demanded.

Also, if the titanium-containing perovskite composite oxide powder undergoes aggregation at the time of mixing the powder with a solvent to form a slurry or a paste, there arises a problem that the sintering density decreases and in turn the electric properties such as breakdown voltage and migration, deteriorate. Furthermore, impurities contained in the titanium-containing perovskite composite oxide particle have an adverse effect on the electric properties.

Accordingly, in order to cope with the tendency toward down-sized, lightweight and high-performance electronic parts, development of a titanium-containing perovskite composite oxide particle having a small particle diameter, a narrow particle size distribution, excellent dispersibility and high purity is necessary.

Conventionally, the titanium-containing perovskite composite oxide particle has been produced by the following methods.

With respect to the production method of a high-purity high-crystalline particulate titanium-containing perovskite composite oxide particle, a flux process is known. However, in this process, not only the production cost is very high but also the particle formation has to be effected by pulverization and therefore, the particles formed have a broad particle size distribution and poor dispersibility. Accordingly, this process is unsuitable for the production of an electronic material using the particles.

Examples of the method generally known for producing a titanium-containing perovskite composite oxide particle for electronic materials include a solid-phase process of using an oxide of Ti, Zr, Hf, and a carbonate of Ca, Sr, Ba, Pb or Mg as raw materials, mixing these powders in a ball mill or the like and reacting the mixture at a high temperature of about 800° C. or more to produce a titanium-containing perovskite composite oxide particle; an oxalate process of preparing an oxalic acid composite salt and thermally decomposing the composite salt to obtain a titanium-containing perovskite composite oxide particle; a hydrothermal synthesis process of reacting raw materials in an aqueous solvent at a high temperature and a high pressure to obtain a precursor; and an alkoxide process of using a metal alkoxide as a raw material and hydrolyzing it to obtain a precursor. The method of producing a titanium-containing perovskite composite oxide particle by using such a process is described, for example, in JP-A-4-114919 (the term “JP-A” as used herein means an “unexamined published Japanese patent application”); JP-A-2002-274937; and JP-B-7-84350 (the term “JP-B” as used herein means an “examined Japanese patent publication”).

Also, with respect to the production method of barium titanate which is one of titanium-containing perovskite composite oxide particles, for example, a process of reacting a hydrolysis product of a titanium compound with a water-soluble barium in a strong alkali (JP-B-3-39014 (EP 104002)), and a process of reacting a titanium oxide sol with a barium compound in an aqueous strong alkali solution (International Patent Publication WO 00/35811 (EP 114803) and International Patent Publication WO 03/004416 (U.S. 2003/0044347) are generally known and studies are being aggressively made to improve these synthesis methods.

The solid-phase process has a problem that despite low production cost, the produced titanium-containing perovskite composite oxide particle has a large particle diameter. The particle diameter may be decreased by pulverizing the particles, but the particle size distribution is broadened and the shaping density may not be enhanced. Furthermore, distortion may be generated in the crystal structure due to pulverization, and a titanium-containing perovskite composite oxide particle suitable for down-sized high-performance electronic parts may not be obtained.

In the oxalate process, a smaller particle than that produced by the solid-phase process is obtained, but a carbonic acid group derived from the oxalic acid remains as an impurity. Furthermore, a large amount of a hydroxyl group attributable to water entrapped inside remains and this gives rise to deterioration of electric properties. In this way, the oxalate process has a problem that a titanium-containing perovskite composite oxide powder with excellent electric properties cannot be obtained.

The hydrothermal synthesis process is disadvantageous in that although a fine particulate barium titanate is obtained, a hydroxyl group attributable to water entrapped inside remains to cause many defects and a titanium-containing perovskite composite oxide particle with excellent electric properties can be hardly obtained. Also, this process is performed under high-temperature high-pressure conditions and therefore, exclusive equipment is necessary, resulting in rising of the cost.

In the alkoxide process, barium titanate finer than that produced by the hydrothermal synthesis process is obtained, but a hydroxyl group attributable to water entrapped inside remains to cause many defects and a titanium-containing perovskite composite oxide particle with excellent electric properties can be hardly obtained.

In the process described in JP-B-3-39014 (EP 104002), potassium hydroxide or sodium hydroxide is used as the alkali, but in order to obtain a high-purity titanium-containing perovskite composite oxide particle, a step of removing such an alkali component after reaction is necessary. In practice, dissolution of barium and entrapment of hydroxyl group simultaneously occur in the removing step and therefore, a titanium-containing perovskite composite oxide particle with high crystallinity can be hardly obtained.

### DISCLOSURE OF THE INVENTION

An object of the present invention is to provide a titanium-containing perovskite composite oxide particle having a small particle diameter, a narrow particle size distribution, good dispersibility, high crystallinity and excellent electric properties, which is represented by the formula: A(TiₓB₍₁₋ₓ₎)_{y}O₃ (wherein x and y each denoting a compositional ratio are 0<x<1 and 0.98≦y≦1.02, A is at least one element selected from Ca, Sr, Ba, Pb and Mg, and B is at least one element selected from Hf and Zr), and a production process thereof.

In order to achieve the above-described object, the present invention provides the following means.

(1) A titanium-containing perovskite composite oxide particle represented by the compositional formula: A(TiₓB₍₁₋ₓ₎)_{y}O₃ (provided that x and y each denoting a compositional ratio are 0<x<1 and 0.98≦y≦1.02, A is at least one element selected from Ca, Sr, Ba, Pb and Mg, and B is at least one element selected from Hf and Zr), wherein the specific surface area is from 1 to 100 m²/g, the average primary particle diameter D1 defined by formula (I) is from 10 to 1,000 nm, and the ratio D2/D1 of D1 to the average secondary particle diameter D2 is from 1 to 10:
D1=6/ρS (I)
(wherein ρ is a density of the particle and S is a specific surface area).

(2) The titanium-containing perovskite composite oxide particle as described in (1) above, wherein assuming that the average particle diameter on the volume basis as determined by an image analysis method is d1, the particle diameter at 5% accumulated from the small particle diameter side is d2, the particle diameter at 95% accumulated from the small particle diameter side is d3 and the maximum particle diameter is d4, d2/d1 is from 0.1 to 1, d3/d1 is from 1 to 1.8 and d4/d1 is from 1 to 2.

(3) The titanium-containing perovskite composite oxide particle as described in (1) or (2) above, wherein the alkali metal content is 100 ppm or less and the chlorine content is 600 ppm or less.

(4) The titanium-containing perovskite composite oxide particle as described in any one of (1) to (3) above, wherein A is Ba, B is Zr, and x denoting the compositional ratio is 0.4≦x<1.

(5) The titanium-containing perovskite composite oxide particle as described in any one of (1) to (3) above, wherein A comprises Ba and Ca, B is Zr, and x denoting the compositional ratio is 0.4≦x<1.

(6) The titanium-containing perovskite composite oxide particle as described in any one of (1) to (3) above, wherein A is Pb, B is Zr, and x denoting the compositional ratio is 0.3≦x≦0.7.

(7) A process for producing the titanium-containing perovskite composite oxide particle described in any one of (1) to (6) above, comprising a step of charging a metal salt containing at least one member selected from Ca, Sr, Ba, Pb and Mg, a particulate titanium oxide and a compound containing at least one member selected from Zr and Hf, in a basic compound-containing alkaline solution and reacting these components.

(8) The production process of a titanium-containing perovskite composite oxide particle as described in (7) above, which comprises a step of removing the basic compound in the form of a gas after the reaction step.

(9) The production process of a titanium-containing perovskite composite oxide particle as described in (7) or (8) above, wherein a heat treatment is performed at a temperature of 350 to 1,500° C. after the step of removing the basic compound.

(10) The production process of a titanium-containing perovskite composite oxide particle as described in any one of (7) to (9) above, wherein the particulate titanium oxide contains a brookite crystal.

(11) The production process of a titanium-containing perovskite composite oxide particle as described in any one of (7) to (10) above, wherein the particulate titanium oxide is a titanium oxide sol obtained by hydrolyzing a titanium compound in an acidic solution.

(12) The production process of a titanium-containing perovskite composite oxide particle as described in any one of (7) to (11) above, wherein the basic compound is a substance which vaporizes under atmospheric pressure or reduced pressure by at least one or more means selected from evaporation, sublimation and thermal decomposition.

(13) The production process of a titanium-containing perovskite composite oxide particle as described in any one of (7) to (12) above, wherein the basic compound is an organic base compound.

(14) The production process of a titanium-containing perovskite composite oxide particle as described in any one of (7) to (13) above, wherein the basic compound is tetramethyl-ammonium hydroxide.

(15_ The production process of a titanium-containing perovskite composite oxide particle as described in any one of (7) to (14) above, wherein the Zr or Hf compound is a water-soluble compound.

(16) The production process of a titanium-containing perovskite composite oxide particle as described in any one of (7) to (15) above, wherein the solubility of the Zr or Hf compound in water is 0.1 mass % or more in terms of ZrO₂ or HfO₂.

(17) The production process of a titanium-containing perovskite composite oxide particle as described in any one of (7) to (16) above, wherein the Zr compound is at least one compound selected from basic zirconium carbonate, zirconium acetate, zirconium nitrate, ammonium zirconium carbonate, zirconium sulfate and zirconium hydroxychloride.

(18) A dielectric material comprising the titanium-containing perovskite composite oxide particle described in any one of (1) to (6) above.

(19) A paste comprising the titanium-containing perovskite composite oxide particle described in any one of (1) to (6) above.

(20) A slurry comprising the titanium-containing perovskite composite oxide particle described in any one of (1) to (6) above.

(21) A thin film-shaped product comprising the titanium-containing perovskite composite oxide particle described in any one of (1) to (6) above.

(22) A dielectric porcelain comprising the titanium-containing perovskite composite oxide particle described in any one of (1) to (6) above.

(23) A pyroelectric porcelain comprising the titanium-containing perovskite composite oxide particle described in any one of (1) to (6) above.

(24) A piezoelectric porcelain comprising the titanium-containing perovskite composite oxide particle described in any one of (1) to (6) above.

(25) A capacitor comprising the dielectric porcelain described in (22) above.

(26) An electronic device comprising at least one member selected from the thin film-shaped product described in (21) above, the porcelain described in anyone of (22) to (4) above, and the capacitor described in (25) above.

(27) A sensor comprising at least one species of the thin film-shaped product and the porcelains described in any one of (21) to (24) above.

(28) A dielectric film comprising the titanium-containing perovskite composite oxide particle described in any one of (1) to (6) above.

(29) A capacitor produced by using the dielectric film described in (28) above.

### EFFECTS OF THE INVENTION

The present invention has a remarkable effect that a titanium-containing perovskite composite oxide particle having a small particle diameter, a narrow particle size distribution and high crystallinity, which is represented by A(TiₓB₍₁₋ₓ₎)_{y}O₃ (wherein 0<x<1, 0.98≦Y≦1.02, A is at least one member selected from Ca, Sr, Ba, Pb and Mg, and B is at least one member selected from Hf and Zr), and a production process thereof can be provided.

The powder of this titanium-containing perovskite composite oxide particle and a slurry or paste containing the powder can exert excellent electric properties. Also, with use of this slurry or paste, a dielectric material, a piezoelectric material, a pyroelectric material or the like having excellent performance, such as porcelain, thin film and dielectric film, can be obtained. Furthermore, when such a material is used for an electronic device, a down-sized lightweight electronic device can be realized. The dielectric film has excellent dielectric property and, therefore, even when formed as a thin film, the dielectric film can exert excellent properties and can be applied to, for example, a capacitor embedded in a substrate. Use of this capacitor in an electronic device such as a cellular phone, digital camera, PDA and various small portable devices is very effective for the realization of a down-sized, lightweight and high-performance device.

### BRIEF DESCRIPTION OF DRAWINGS

FIG. 1 is a cross-sectional schematic view of a multilayer ceramic capacitor in a preferred embodiment of the present invention.

FIG. 2 is an exploded view showing the internal structure of a cellular phone equipped with the multilayer ceramic capacitor of FIG. 1.

FIG. 3 is an X-ray diffraction spectrum diagram of the Ba(Ti_{0.8}Zr_{0.2})O₃ powder of Example 1.

FIG. 4 is a scanning electron microphotograph of the Ba(Ti_{0.8}Zr_{0.2})O₃ powder of Example 1.

FIG. 5 is an X-ray diffraction spectrum diagram of the (Ba_{0.95}Ca_{0.05})(Ti_{0.8}Zr_{0.2})O₃ powder of Example 4.

### BEST MODE FOR CARRYING OUT THE INVENTION

The present invention is described in detail below.

The titanium-containing perovskite composite oxide particle in a preferred embodiment of the present invention is a solid-solution perovskite compound represented by the compositional formula: A(TiₓB₍₁₋ₓ₎)yO₃ (wherein x and y each denoting a compositional ratio are 0<x<1 and 0.98≦y≦1.02, A is at least one element selected from Ca, Sr, Ba, Pb and Mg, and B is at least element selected from Hf and Zr). The term “solid-solution” as used herein means a state that atoms are not merely “mixed” but are solid-dissolved at a constant ratio. The crystal structure of the titanium-containing perovskite composite oxide particle in a preferred embodiment of the present invention can be confirmed by the X-ray diffraction measurement, and the ratio (solid solution ratio) x between Ti and B in the titanium-containing perovskite composite oxide particle can be determined from the peak positions in the X-ray diffraction diagram.

The ratio (solid solution ratio) x between Ti and B in the powder is 0<x<1, preferably 0.2≦x<1, more preferably 0.3≦x<1, still more preferably 0.4≦x<1.

The ratio (y) of the molar number of A to the total molar number of titanium and B is preferably from 0.98 to 1.02, more preferably from 0.995 to 1.015, still more preferably from 0.99 to 1.01, and this ratio is adjusted so that desired electric properties can be attained. The ratio (y) is preferably closer to 1, because the defects are less generated and the crystallinity becomes higher.

In the titanium-containing perovskite composite oxide particle in a preferred embodiment of the present invention, another compound may be added and used to improve the electric properties.

In general, for the purpose of downsizing an electronic device, a specific surface area less than 1 m²/g is not preferred because the particle diameter is too large and ineffective, whereas if the specific surface area exceeds 100 m²/g, the powder readily undergoes aggregation and its handling becomes difficult. The titanium-containing perovskite composite oxide particle in a preferred embodiment of the present invention has a specific surface area of 1 to 100 m²/g. Incidentally, a specific surface area value determined by the BET method is preferably employed in the present invention.

The titanium-containing perovskite composite oxide particle of the present invention is a fine particle and this particle has a narrow particle diameter distribution and excellent dispersibility with less aggregation. Here, the average primary particle diameter D1 can be determined in terms of a sphere according to the following formula (I) from the specific surface area of a particle measured by the BET method.
D1=6/ρS (I)
wherein ρ is a specific gravity of the particle and S is a specific surface area of the particle.

Also, fine particles of the titanium-containing perovskite composite oxide particle are dispersed in a solvent and the secondary particle diameter of aggregate particle is measured by a particle size distribution analyzer. In general, a particle size distribution analyzer suitable for the range of particle size distribution to be measured is selected. The secondary particle diameter of the titanium-containing perovskite composite oxide particle of the present invention can be measured by a centrifugal precipitation method, a Microtrac method, an electro-zone method (Coulter counter), a light scattering method or the like, but in view of good sensitivity, the secondary particle diameter is preferably measured by a light scattering method. The particle size distribution of secondary particles is measured by this method and the average particle diameter (or the particle diameter at 50% from smallest) D2 is determined. The particle diameter determined here is an equivalent-sphere diameter.

The ratio (D2/D1 value) of the average secondary particle diameter D2 to the average primary particle diameter D1 is minimally 1 in theory when the particles measured both are spherical. As the D2/D1 value is larger, this indicates that the primary particles are aggregated and the dispersibility is decreased. In the present invention, the D2/D1 value of the composite oxide fine particles is from 1 to 10, preferably from 1 to 9, more preferably from 1 to 8.

In the titanium-containing perovskite composite oxide particle according to a preferred embodiment of the present invention, assuming that the average particle diameter on the volume basis as determined by an image analysis method is d1, the particle diameter at 5% accumulated from the small particle diameter side is d2, the particle diameter at 95% is d3 and the maximum particle diameter is d4, d2/d1 is preferably from 0.1 to 1, d3/d1 is preferably from 1 to 1.8 and d4/d1 is preferably from 1 to 2.

As the d2/d1, d3/d1 and d4/d1 values each comes closer to 1, the particle size distribution of primary particles becomes narrower and this is preferred. In a preferred embodiment of the present invention, d2/d1 is from 0.1 to 1, preferably from 0.2 to 1. Also, in a preferred embodiment of the present invention, d3/d1 is from 1 to 1.8, preferably from 1 to 1.7. Furthermore, in a preferred embodiment of the present invention, d4/d1 is from 1 to 2, preferably from 1 to 1.9.

In the titanium-containing perovskite composite oxide particle according to a preferred embodiment of the present invention, the alkali metal content is preferably 100 ppm or less, more preferably from 0 to 80 ppm, and the chlorine content is preferably 600 ppm or less, more preferably from 0 to 300 ppm.

Such a titanium-containing perovskite composite oxide particle has a small particle diameter and excellent electric properties with high dielectric constant and by using a dielectric material such as a dielectric porcelain obtained therefrom, a down-sized electronic part such as a multilayer ceramic capacitor is obtained. Furthermore, by using such an electronic part, reduction in the size and weight of an electronic device can be realized.

The preferred process for producing a titanium-containing perovskite composite oxide particle of the present invention is described below.

In the preferred process for producing a titanium-containing perovskite composite oxide particle of the present invention, a particulate titanium oxide, a metal salt containing at lease one member selected from Ca, Sr, Ba, Pb and Mg, and a compound containing at least one member selected from Zr and Hf are charged into an alkaline solution in which a basic compound is present.

After the reaction, the basic compound is removed in the form of a gas through evaporation, sublimation and/or thermal decomposition under atmospheric or reduced pressure in a temperature range from room temperature to firing temperature to produce a titanium-containing perovskite composite oxide particle.

In the production process of a titanium-containing perovskite composite oxide particle according to a preferred embodiment of the present invention, an alkaline solution in which a basic compound is present is preferably used. The reasons therefor are not clearly known but are assumed to be that as the alkalinity is higher, the reaction among A ion, B ion and titanium oxide more readily proceeds. The pH of the solution is 10 or more, preferably 13 or more, more preferably 14 or more. The upper limit of the amount charged of the basic compound is a saturated solubility of the basic compound in water.

In the production process of a titanium-containing perovskite composite oxide particle according to a preferred embodiment of the present invention, a particulate titanium oxide, a metal salt containing at least one member selected from Ca, Sr, Ba, Pb and Mg, and a compound containing at least one member selected from Zr and Hf are used at an arbitrary ratio, whereby a titanium-containing perovskite composite oxide particle having a corresponding x/y ratio is produced.

In the case of producing, for example, barium titanate zirconate, a particulate titanium oxide, a metal salt of Ba, and a Zr compound are used at an arbitrary ratio, whereby barium titanate zirconate having a corresponding compositional ratio can be produced. For example, Ba(Ti_{0.8}Zr_{0.2})O₃ can be produced by charging a metal salt of Ba:a Zr compound:titanium oxide=10 mol:2 mol:8 mol, and Ba(Ti_{0.9}Zr_{0.1})O₃ can be produced by charging a metal salt of Ba:a Zr compound:titanium oxide=10 mol:1 mol:9 mol.

The method and order of charging a particulate titanium oxide, a metal salt containing at least one member selected from Ca, Sr, Ba, Pb and Mg, and a compound containing at least one member selected from Zr and Hf are not particularly limited.

The above-described synthesis reaction is performed most industrially with stirring under heat. In particular, mechanical stirring is preferred because the raw materials are mixed with each other. Also, since the reaction solution is alkaline and readily absorbs CO₂ in air, the reaction is preferably performed in a closed system or while blowing an inert gas so as to keep the reaction solution from coming into contact with air. If CO₂ is absorbed into the reaction solution, this is contained as a carbonic acid group in the reaction solution, and the carbonic acid group (containing CO₂, H₂CO₃, HCO₃⁻ and CO₃²⁻ as carbonic acid species) reacts with a metal salt containing at least one member selected from Ca, Sr, Ba, Pb and Mg to produce a stable carbonate. This carbonate does not react with titanium oxide and tends to remain as an impurity in the titanium-containing perovskite composite oxide particle. Accordingly, the carbonic acid group concentration (in terms of CO₂; unless otherwise indicated, the same applies in the following) in the reaction solution is preferably controlled. By controlling the carbonic acid concentration, a titanium-containing perovskite composite oxide particle with high purity can be stably produced.

The concentration in terms of CO₂ in the reaction solution is preferably 500 ppm by mass or less, more preferably 200 ppm by mass or less, still more preferably from 0 to 100 ppm by mass. In order to reduce the carbonic acid group concentration in the reaction solution, water before dissolving a basic compound therein is preferably heat-treated immediately before the production and thereby decarboxylated.

Also, the reaction temperature is preferably set as high as possible for elevating the crystallinity of the titanium-containing perovskite composite oxide particle. The temperature is kept at 40 to 120° C., preferably 80 to 120° C., under heating. In order to elevate the reaction temperature, a hydrothermal reaction up to the critical temperature of the solution is possible, but this requires equipment assured of safety, such as autoclave. Accordingly, the reaction is preferably performed by boiling the solution at 95° C. or more and keeping the temperature.

The reaction time for producing the titanium-containing perovskite composite oxide particle is usually 2 hours or more, preferably 3 hours or more, more preferably 4 hours or more.

Examples of the impurity adversely affecting the electric properties of the titanium-containing perovskite composite oxide particle include trace components such as metal ion and anion. These impurities can be removed by various methods such as a method of subjecting the slurry after the completion of reaction to electrodialysis, ion exchange, water washing, acid cleaning or a treatment with a permeable membrane. However, such a method must be performed with care, because barium and the like contained in the titanium-containing perovskite composite oxide particle may be ionized simultaneously with the impurity ion and partially dissolved in the slurry, as a result, not only a particulate titanium oxide, a metal salt containing at least one member selected from Ca, Sr, Ba, Pb and Mg, and a compound containing at least one member selected from Zr and Hf can be hardly solid-dissolved at a desired ratio but also the crystallinity may decrease due to generation of defects in the crystal. Furthermore, since the reaction solution is alkaline, carbon dioxide in air is readily mingled during the above-described treatment and the carbonate content in the titanium-containing perovskite composite oxide particle sometimes increases.

From these reasons, it is preferred to select raw materials having less impurities and at the same time, prevent mingling of impurities during the synthesis reaction and firing. In addition, after the completion of synthesis reaction, the impurities are preferably removed in the form of a gas through evaporation, sublimation and/or thermal decomposition under atmospheric or reduced pressure in a temperature range from room temperature to firing possible temperature. At this time, the basic compound contained in the alkali solution is preferably decomposed at the same time and removed in the form of a gas.

Firing is generally performed for enhancing the crystallinity of a titanium-containing perovskite composite oxide particle but on the other hand, impurities can be evaporated, sublimated and/or thermally decomposed by firing and removed in the form of a gas. Examples of the impurity removable by this method include an organic base such as organic amine having a small carbon number and hydroxide of ammonia salt, and a trace organic material or carbonate contained as impurities in raw materials. The firing is usually performed at a firing possible temperature of 350 to 1,500° C. The firing atmosphere is not particularly limited and the firing is usually performed in air or under reduced pressure.

Incidentally, in view of reduction in the heat energy for firing or enhancement of the crystallinity, the slurry after the completion of synthesis reaction is preferably subjected to solid-liquid separation and then fired. The solid-liquid separation contains the steps of precipitation, concentration, filtration, and/or drying and pulverization of the powder. By the precipitation, concentration and filtration, impurities dissolved in the solution can be removed. A coagulant or dispersant may be used so as to change the precipitation rate or filtration rate. The coagulant or dispersant is preferably a substance removable in the form of a gas through evaporation, sublimation and/or thermal decomposition.

The drying step is a step of evaporating the water content, but depending on the kind of the basic compound or impurity, a part or the entire amount of impurities can be removed through evaporation, sublimation and/or thermal decomposition. For the drying, a method such as drying under reduced pressure, hot-air drying or freeze-drying is used. The drying is usually performed at room temperature to 350° C. for 1 to 24 hours. The drying atmosphere is not particularly limited, but the drying is usually performed in air or inert gas or under reduced pressure. Thereafter, the powder may be pulverized by an appropriate method.

The metal salt containing at least one member selected from Ca, Sr, Ba, Pb and Mg, which is used in the present invention, is not particularly limited and may be sufficient if it is a metal salt containing such a metal. This metal salt is preferably water-soluble and generally a nitrate, an acetate, a chloride salt, a hydroxide or the like. One of these metal salts may be used alone, or two or more thereof may be mixed at an arbitrary ratio. More specifically, for example, in the case of Ba, barium chloride, barium nitrate, barium acetate or the like is used and in the case of Sr, strontium chloride, strontium nitrate, strontium acetate or the like is used. Among these, a hydroxide is preferred as the metal salt containing at least one member selected from Ca, Sr, Ba, Pb and Mg, because an anion of the metal salt, which adversely affects the electric properties after the reaction, does not remain. More specifically, for example, in the case of Ba, barium hydroxide is used and in the case of Sr, strontium hydroxide is used. The hydroxide may be either an anhydrous salt or a hydrate and this is not particularly limited as long as it is a hydroxide.

Also, the particulate titanium oxide for use in the present invention is not particularly limited but is preferably a particulate titanium oxide containing a brookite crystal, or a particulate titanium oxide obtained by hydrolyzing a titanium salt in an acidic solution.

As long as a brookite crystal is contained, the particulate titanium oxide may contain a brookite titanium oxide alone or may contain a rutile titanium oxide or an anatase titanium oxide. In the case of containing a rutile titanium oxide or an anatase titanium oxide, the proportion of the brookite titanium oxide in the titanium oxide is not particularly limited but is generally from 1 to 100 mass %, preferably from 10 to 100 mass %, more preferably from 50 to 100 mass %. In order to obtain a titanium oxide powder having excellent dispersibility in a solvent, crystalline structure is more preferred than amorphous structure, because simple particles are readily formed. Particularly, the brookite titanium oxide exhibits excellent dispersibility. The reason therefor is not clearly known but this is considered to have relationship with the fact the zeta potential of the brookite crystal at a pH of 2 is higher than that of the rutile or anatase crystal.

Examples of the method for producing a particulate titanium oxide containing a brookite crystal include a production process of obtaining a particulate titanium oxide containing a brookite crystal by heat-treating a particulate anatase titanium oxide; and a liquid-phase production process of obtaining a titanium oxide sol having dispersed therein titanium oxide particles by neutralizing or hydrolyzing a solution of a titanium compound such as titanium tetrachloride, titanium trichloride, titanium alkoxide or titanium sulfate.

In the case of using a brookite crystal-containing particulate titanium oxide as the production raw material, a titanium oxide sol obtained by hydrolyzing a titanium salt in an acidic solution is preferably used for the particulate titanium oxide. The powder of this titanium oxide sol has a small particle diameter and excellent dispersibility. The method for producing the titanium oxide sol is preferably, for example, a method where titanium tetrachloride is added to hot water at 75 to 100° C., and the titanium tetrachloride is hydrolyzed while controlling the chloride ion concentration at a temperature from 75° C. to the boiling point of the solution, thereby obtaining a brookite crystal-containing particulate titanium oxide in the form of a sol (see, JP-A-11-43327), or a method where titanium tetrachloride is added to hot water at 75 to 100° C., and the titanium tetrachloride is hydrolyzed in the presence of either one or both of a nitrate ion and a phosphate ion while controlling the total concentration of chloride ion, nitrate ion and phosphate ion at a temperature from 75° C. to the boiling point of the solution, thereby obtaining a brookite crystal-containing particulate titanium oxide in the form of a sol. (See, International Patent Publication WO 99/58451 (U.S. Pat. No. 6,627,336).

As for the size of the thus-obtained brookite crystal-containing particulate titanium oxide, the primary powder diameter is usually from 1 to 1,000 nm, preferably from 3 to 50 nm, more preferably from 5 to 20 nm. If the primary powder diameter exceeds 1,000 nm, the titanium-containing perovskite composite oxide powder produced by using this particulate titanium oxide as the raw material comes to have a large particle diameter and may be unsuited for functional materials such as a dielectric material and a piezoelectric material, whereas if the primary powder diameter is less than 1 nm, the handling in the process of producing the particulate titanium oxide is sometimes difficult.

In the case of using a titanium oxide sol obtained by hydrolyzing a titanium salt in an acidic solution, the titanium oxide is not limited in its crystal form and not limited to a brookite crystal phase.

When a titanium salt such as titanium tetrachloride or titanium sulfate is hydrolyzed in an acidic solution, the reaction rate is reduced as compared with the case of performing the hydrolysis in a neutral or alkaline solution and therefore, a titanium oxide sol having a simple particle diameter and excellent dispersibility is obtained. Furthermore, an anion such as a chloride ion and a sulfate ion can be hardly entrapped inside the produced titanium oxide particle and therefore, when titanium-containing perovskite composite oxide particle particles are produced, mingling of an anion into the particle can be decreased.

On the other hand, if the hydrolysis is performed in a neutral or alkaline solution, the reaction rate increases and many nucleations occur in the initial stage, as a result, a titanium oxide sol having bad dispersibility despite a small particle diameter is produced and the powder may be aggregated. If a titanium-containing perovskite composite oxide powder is produced by using such a titanium oxide sol as the raw material, the obtained powder may suffer from bad dispersibility despite a small particle diameter. In addition, an anion readily mingles inside the titanium oxide powder and removal of such an anion in the subsequent step is sometimes difficult.

The method for hydrolyzing a titanium salt in an acidic solution to obtain a titanium oxide sol is not particularly limited as long as the solution can be kept acidic, but a method of using titanium tetrachloride as the raw material, performing the hydrolysis in a reactor equipped with a reflux condenser, and keeping the solution acidic by suppressing the escape of chlorine generated there (JP-A-11-43327) is preferred.

The concentration of the titanium salt in the acidic solution is preferably from 0.01 to 5 mol/L, because if the concentration exceeds 5 mol/L, the reaction rate of hydrolysis increases and a titanium oxide sol with a large particle size and bad dispersibility may be obtained, whereas if it is less than 0.01 mol/L, the concentration of the titanium oxide obtained may decrease, giving rise to bad productivity.

The method for charging the titanium oxide sol is not particularly limited, but in order to prevent aggregation of the titanium oxide sol and obtain a titanium-containing perovskite composite oxide particle having excellent dispersibility, the titanium oxide sol is preferably charged little by little into an alkaline solution at a pH of 10 or more. Examples of the method for charging the titanium oxide sol little by little include dropwise addition with use of a pump or the like, and injection into the solution.

In the present invention, a basic compound is contained in the alkaline solution used as a reaction solution and by virtue of this basic compound, the pH of the alkaline solution is kept to 10 or more. The basic compound is not particularly limited but is preferably a substance which becomes a gas through evaporation, sublimation and/or thermal decomposition under atmospheric or reduced pressure. The basic compound is preferably, for example, an organic base such as ammonia, an organic amine having high solubility in water and having a small carbon number, and a hydroxide of an ammonium salt.

Among these, a hydroxide of an ammonium salt is more preferred, because when dissolved in water, this base exhibits high dissociation, acts as a strong base and is not volatilized at the reaction. On the other hand, ammonia and an organic amine having high solubility in water and having a small carbon number are weak as a base and sometimes difficult to use due to their low boiling point.

As for the hydroxide of an ammonium salt, choline, tetramethylammonium hydroxide (TMAH) and the like are industrially known and these are inexpensively available. Particularly, tetrarnethylammonium hydroxide is being used in the electronic industry and is preferred because not only those reduced in impurities such as metal ion are available, but also this hydroxide can be removed in the form of a gas by undergoing thermal decomposition at 135 to 140° C.

The titanium-containing perovskite composite oxide particle of the present invention can also be produced even by using an inexpensive inorganic compound such as lithium hydroxide, sodium hydroxide and potassium hydroxide.

Such a base compound is not particularly limited and one of these base compounds may be used alone or two or more thereof may be mixed at an arbitrary ratio and used.

The Zr or Hf compound for use in the present invention is not particularly limited but is preferably a water-soluble compound. The reason therefor is not clearly known but is assumed to be that as the solubility in water is higher, the reaction with A ion or B ion readily proceeds.

Particularly, a compound having a solubility in water of 0.1 mass % or more in terms of ZrO₂ or HfO₂ is preferred. The solubility in water is more preferably 1 mass % or more, still more preferably 10 mass % or more.

The Zr or Hf compound is not limited in its form in an aqueous solution and takes a form such as an oxonium ion, an aqua complex, an anionic Zr, or a Hf ion.

Preferred examples of the Zr compound include zirconium hydroxide in which the hydroxyl group is partially or entirely substituted, and anionic zirconium. Examples of the substituent include acetic acid, nitric acid, sulfuric acid, chlorine and carbonic acid. Also, such a zirconium compound may be a hydrate.

Specific examples of the Zr compound include zirconium acetate, zirconium nitrate, ammonium zirconium carbonate, zirconium sulfate and zirconium hydroxychloride. Among these, ammonium zirconium carbonate is preferred because impurities such as ammonia and carbonic acid group produced as a by-product after the completion of synthesis reaction can be removed in the form of a gas through evaporation, sublimation and/or thermal decomposition in a temperature range from room temperature to firing possible temperature under atmospheric or reduced pressure.

The method for charging the Zr or Hf compound is not particularly limited, but in order to prevent aggregation of the Zr or Hf compound and obtain a titanium-containing perovskite composite oxide particle having excellent dispersibility, the Zr or Hf compound is preferably charged little by little into an alkaline solution at a pH of 10 or more. Examples of the method for charging the Zr or Hf compound little by little include dropwise addition with use of a pump or the like, and injection into the solution.

The thus-produced titanium-containing perovskite composite oxide powder is a titanium-containing perovskite composite oxide having a small particle diameter, a narrow particle diameter distribution, good dispersibility, high crystallinity and excellent electric properties, and particularly reduced in impurities. This powder is molded into a dielectric porcelain, a pyroelectric porcelain, a piezoelectric porcelain or a thin-film shaped article.

Such a porcelain or thin-film shaped article is used for a capacitor material, a sensor or the like.

The titanium-containing perovskite composite oxide powder may also be used after this powder alone or mixed, for example, with additives or other materials is formed into a slurry or paste by using one or more solvents comprising water or an existing inorganic or organic binder.

The electric properties of the titanium-containing perovskite composite oxide powder can be evaluated by firing a disc shaped after adding various additives such as sintering aid to the powder or a thin-film product shaped after adding various additives to the slurry or paste containing the powder, under appropriate conditions and then measuring the fired body with use of an impedance analyzer or the like.

When a filler containing the titanium-containing perovskite composite oxide powder is dispersed in at least one member selected from a thermosetting resin and a thermoplastic resin, a film with high dielectric constant can be obtained.

In the case of incorporating a filler other than titanium-containing perovskite composite oxide powder, one or more members selected from the group consisting of alumina, titania, zirconia and tantalum oxide may be used.

The thermosetting resin and thermoplastic resin are not particularly limited and a generally employed resin may be used, but suitable examples of the thermosetting resin include epoxy resin, polyimide resin, polyamide resin and bistriazine resin, and suitable examples of the thermoplastic resin include polyolefin resin, styrene-based resin and polyamide.

In order to uniformly disperse a filler containing the titanium-containing perovskite composite oxide powder in at least one member selected from a thermosetting resin and a thermoplastic resin, a slurry is preferably obtained by previously dispersing the filler in a solvent or in a mixture of the above-described resin composition and a solvent.

The method for obtaining a slurry by dispersing the filler in a solvent or in a mixture of the resin composition and a solvent is not particularly limited but preferably contains a wet pulverization step.

The solvent is not particularly limited and any solvent may be used as long as it is a generally employed solvent, but, for example, methyl ethyl ketone, toluene, ethyl acetate, methanol, ethanol, N,N-dimethylformamide, N,N-dimethylacetamide, N-methylpyrrolidone and methyl cellosolve may be used individually or in combination of two or more thereof.

In order to obtain a slurry by dispersing the filler in a solvent or in a mixture of the resin composition and a solvent, the filler is preferably treated with a coupling agent. The coupling agent is not particularly limited and examples thereof include a silane coupling agent, a titanate-based coupling agent and an aluminate-based coupling agent. The hydroxyl group of the coupling agent reacts with an active hydrogen on the surface of the filler containing the titanium-containing perovskite composite oxide powder of the present invention to cover the surface and, therefore, dispersibility in a solvent is enhanced. Also, by selecting the hydrophobic group of the coupling agent, compatibility with the resin may be enhanced. For example, in the case of using an epoxy resin as the resin, the coupling agent is suitably a silane coupling agent having a functional group such as a monoamino, diamino, cationic styryl, epoxy, mercapto, anilino or ureido group and the like, or a titanate-based coupling agent having a functional group such as a phosphite, amino, diamino, epoxy or mercapto group and the like. In the case of using a polyimide resin as the resin, the coupling agent is preferably a silane coupling agent having a functional group such as a monoamino, diamino or anilino group and the like, or a titanate-based coupling agent having a functional group such as a monoamino or diamino group and the like.

One of these coupling agents may be used alone, or two or more thereof may be mixed and used.

The amount blended of the coupling agent is not particularly limited and it may sufficient if the titanium-containing perovskite composite oxide powder is partially or entirely covered. However, if the amount blended is too large, the coupling agent may remain unreacted and give an adverse effect, whereas if the amount blended is too small, the coupling effect may decrease. Accordingly, the amount blended is preferably selected to allow for uniform dispersion of the filler depending on the particle diameter and specific surface area of the filler containing the titanium-containing perovskite composite oxide powder, or the kind of the coupling agent. The amount blended of the coupling agent is preferably on the order of 0.05 to 20 mass % based on the filler containing the titanium-containing perovskite composite oxide powder.

In order to complete the reaction between the hydrophilic group of the coupling agent and the active hydrogen on the surface of the filler containing the titanium-containing perovskite composite oxide powder, a step of heat-treating the slurry formed is preferably provided. The heating temperature and heating time are not particularly limited, but the heat-treatment is preferably performed at 100 to 150° C. for 1 to 3 hours. When the boiling point of the solvent is 100° C. or less, the heating temperature is set to be lower than the boiling point of the solvent, and the heating time may be prolonged according to the heating temperature set.

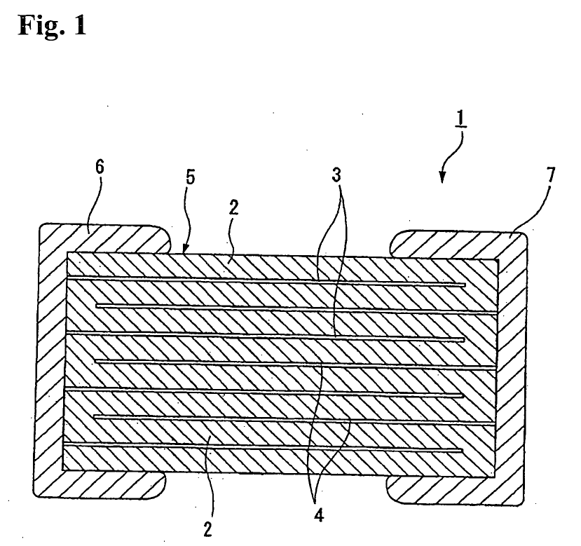

FIG. 1 is a cross-sectional schematic view of a multilayer ceramic capacitor as one example of the capacitor. As shown in FIG. 1, a multilayer ceramic capacitor 1 comprises a stacked body 5 in which a dielectric layer 2 and internal electrodes 3 and 4 are sequentially stacked, and external electrodes 6 and 7 fixed on the side surfaces of the stacked body 5. The internal electrodes 3 and 4 each is exposed at one end to the side surface of the stacked body 5 and each one end is connected to the external electrode 6 or 7.

The dielectric layer 2 is formed by solidifying and shaping the titanium-containing perovskite composite oxide powder with use of a binder or the like, and the internal electrodes 3 and 4 each comprises, for example, Ni, Pd or Ag. The external electrodes 6 and 7 each comprises, for example, a sintered body of Ag, Cu or Ni, which is subjected to Ni plating.

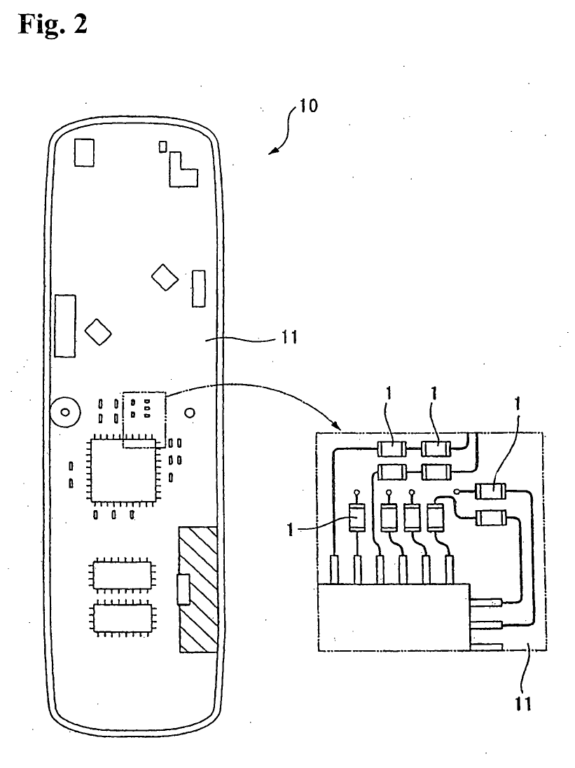

The capacitor 1 shown in FIG. 1 is used, for example, by packaging it, as shown in FIG. 2, on a circuit board 11 of a cellular phone 10.

One example of the production method of the multilayer ceramic capacitor is described below.

A titanium-containing perovskite composite oxide powder, a binder, a dispersant and water are mixed to produce a slurry. The slurry is preferably vacuum-deaerated in advance.

This slurry is thinly coated on a substrate by a doctor blade method or the like and then heated to evaporate water, whereby a dielectric layer mainly comprising a titanium-containing perovskite composite oxide powder is formed.

On this dielectric layer, a metal paste such as Ni, Pd and Ag is coated, another dielectric layer is stacked thereon, and a metal paste working out to the internal electrode is further coated. This step is repeatedly performed, whereby a stacked body in which a dielectric layer and an internal electrode are sequentially stacked is obtained. The stacked body is preferably pressed to tightly contact the dielectric layer and the internal electrode.

Subsequently, the stacked body is cut into a capacitor size and fired at 1,000 to 1,350° C. After the firing, an external electrode paste is coated on the side surfaces of the stacked body and fired at 600 to 850° C. Finally, the surface of the external electrode is subjected to Ni plating.

In this way, a multilayer ceramic capacitor 1 shown in FIG. 1 is obtained.

In the multilayer ceramic capacitor 1 obtained above, a titanium-containing perovskite composite oxide particle having a high dielectric constant, which is a preferred embodiment of the present invention, is used for the dielectric material, so that the electrostatic capacitance of the capacitor can be increased. Furthermore, in the capacitor 1, a titanium-containing perovskite composite oxide particle having a small particle diameter, which is a preferred embodiment of the present invention, is used for the electric material, so that the thickness of the dielectric layer can be made small and in turn, the capacitor itself can be down-sized. Also, by virtue of the decreased thickness of the dielectric layer, the electrostatic capacitance of the capacitor can be more increased.

This down-sized multilayer ceramic capacitor can be suitably used as a component of electronic devices, particularly a portable device including a cellular phone.

### EXAMPLES

The present invention is described in greater detail below by referring to Examples and Comparative Examples, but the present invention is not limited to these Examples.

### Example 1

An aqueous solution containing titanium tetrachloride (produced by Sumitomo Titanium Corp., purity: 99.9%) at a concentration of 0.25 mol/L was prepared. This aqueous solution was charged into a reactor with a reflux condenser and heated to a temperature near the boiling point while preventing escape of chloride ion and keeping the solution acidic. The solution was kept at that temperature for 60 minutes, thereby hydrolyzing titanium tetrachloride to obtain a titanium oxide sol. The obtained titanium oxide sol was dried at 110° C. and the crystal form was examined by an X-ray diffraction apparatus (RAD-B, Rotor Flex, manufactured by Rigaku Corporation), as a result, this titanium oxide was found to be a brookite titanium oxide.

Thereafter, 450 g of an aqueous 20 mass % tetra-methylammonium hydroxide (TMAH) solution (produced by Sachem Showa, carbonic acid group concentration: 60 ppm or less) and 126 g of barium hydroxide octahydrate (produced by Nippon Chemical Industrial Co., Ltd.) were charged into a reactor with a reflux condenser and after adjusting the pH to 14, the aqueous solution was boiled with stirring. The titanium oxide sol obtained above was treated in an electrodialyzer to decrease the chloride ion to 500 ppm and after precipitation and concentration, 171 g of the resulting sol having a titanium oxide concentration of 15 mass % was added dropwise to the reactor at a rate of 7 g/min.

Subsequently, 49 g of ammonium zirconium carbonate (AZC (containing 20 mass % of Zr in terms of ZrO₂), produced by Nippon Light Metal Co., Ltd.) was added dropwise to the reactor at a rate of 7 g/min and while stirring as-is, boiling was maintained for 4 hours.

The resulting reaction solution was filtered, and the obtained filter cake was dried at 300° C. for 5 hours to produce a dry powder.

The dry powder was pulverized in a mortar, and the obtained powder was charged into an electric furnace (KDFP-90, manufactured by DENKEN Co., Ltd.) and heat-treated. The heat treatment was performed under the conditions that the temperature was elevated at 20° C./min and kept at 950° C. for 2 hours and then the powder was naturally cooled.

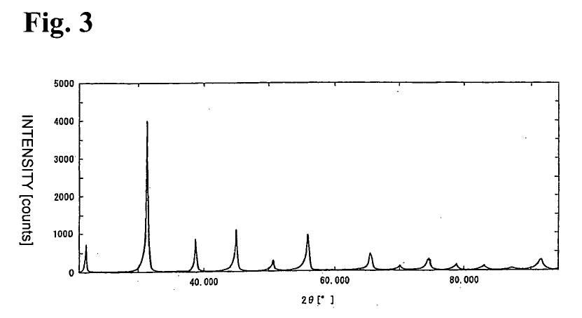

This powder was evaluated by using an X-ray diffraction apparatus (RAD-B, Rotor Flex, manufactured by Rigaku Corporation). FIG. 3 shows the X-ray diffraction spectrum in this evaluation. When the Rietveld analysis was performed based on the X-ray diffraction intensity, the obtained powder was found to be a Ba(Ti_{0.8}Zr_{0.2})O₃ powder.

When the specific surface area of the obtained powder was measured by the BET method, the specific surface area of the powder was 19 m²/g. The average primary particle diameter D1 calculated according to formula (I) was 0.053 μm. Also, the powder was dispersed in pure water and the average secondary particle diameter D2 was measured by a light scattering particle size distribution measuring apparatus (ELS-8000, manufactured by Otsuka Electronics Co., Ltd.). Marquadt was used as the analysis means. The average secondary particle diameter D2 was 0.38 μm and D2/D1 was found to be 7.2.

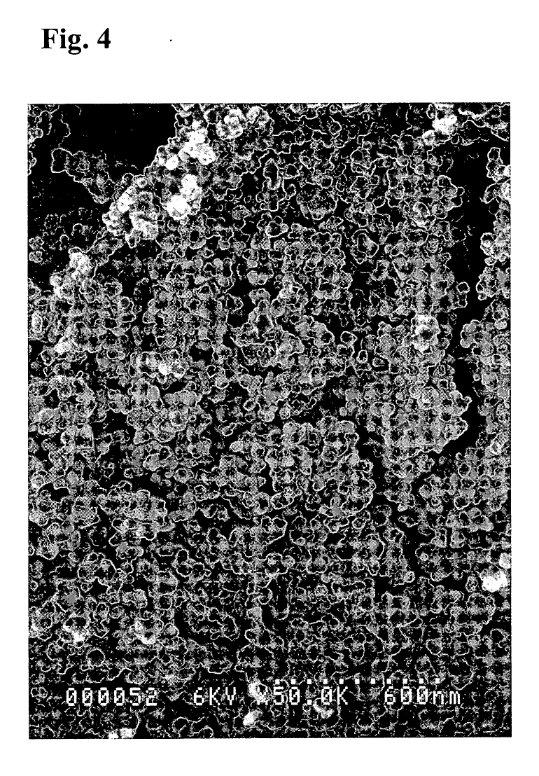

The powder shape was enlargedly observed by a scanning electron microscope. FIG. 4 shows the results.

In the photograph shown in FIG. 4, the diameter of one particle was determined from the average of maximum length and the minimum length. Similarly, the volumes of randomly selected 500 powder particles were determined and arranged in the increasing order of diameter to obtain a particle diameter distribution on the volume basis of particles. Assuming that the average particle diameter on the volume basis as determined by this image analysis method is d1, the particle diameter at 5% accumulated from the small particle diameter side is d2, the particle diameter at 95% is d3 and the maximum particle diameter is d4, d2/d1 was 0.6, d3/d1 was 1.4 and d4/d1 was 1.6.

The dry powder was then dissolved and the amount of potassium (K) ion was measured by ICP spectrometry, as a result, 30 ppm of K ion was contained. Also, the amount of chloride (Cl) ion was measured by anion chromatography, as a result, 80 ppm of Cl ion was contained.

### Example 2

A barium titanate zirconate powder was produced in the same manner as in Example 1, except for using a commercially available anatase titanium oxide sol (STS-02, produced by Ishihara Sangyo Kaisha Ltd.) in place of the brookite titanium oxide sol synthesized in Example 1.

The dry powder was pulverized in a mortar, and the obtained powder was heat-treated at 950° C. for 2 hours. When the Rietveld analysis was performed based on the X-ray diffraction intensity, this powder was found to be a Ba(Ti_{0.8}Zr_{0.2})O₃ powder.

The specific surface area was 23 m²/g and according to formula (I), D1 was 0.043 μm. Also, D2 was 0.38 μm and thus, D2/D1 was found to be 8.8. Furthermore, d2/d1 as determined by the image analysis was 0.4, d3/d1 was 1.5 and d4/d1 was 1.8.

The dry powder was dissolved and the amount of K ion was measured by ICP spectrometry, as a result, 50 ppm of K ion was contained. Also, the amount of Cl ion was measured by anion chromatography, as a result, 110 ppm of Cl ion was contained.

### Example 3

A barium titanate zirconate powder was produced in the same manner as in Example 1, except for using 49 g of zirconium nitrate (containing 20 mass % of Zr in terms of ZrO₂, produced by Nippon Light Metal Co., Ltd.) as the Zr compound.

The dry powder was pulverized in a mortar, and the obtained powder was heat-treated at 950° C. for 2 hours. When the Rietveld analysis was performed based on the X-ray diffraction intensity, this powder was found to be a Ba(Ti_{0.8}Zr_{0.2})O₃ powder having solid-dissolved therein barium, titanium and zirconium.

The specific surface area was 15 m²/g and according to formula (I), D1 was 0.067 μm. Also, D2 was 0.58 μm and thus, D2/D1 was found to be 8.7. Furthermore, d2/d1 as determined by the image analysis was 0.5, d3/d1 was 1.3 and d4/d1 was 1.7.

The dry powder was dissolved and the amount of K ion was measured by ICP spectrometry, as a result, 50 ppm of K ion was contained. Also, the amount of Cl ion was measured by anion chromatography, as a result, 90 ppm of Cl ion was contained.

### Example 4

A barium calcium titanate zirconate powder was produced in the same manner as in Example 1, except for charging 120 g of barium hydroxide octahydrate and 1.5 g of calcium hydroxide in place of charging 126 g of barium hydroxide octahydrate.

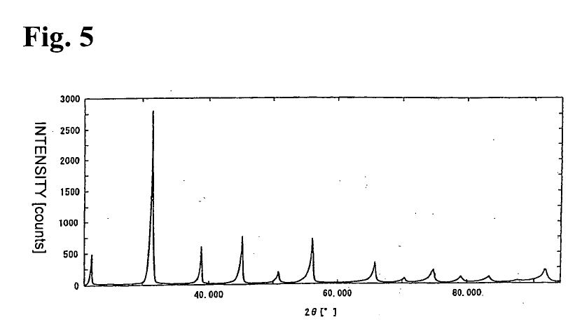

The dry powder was pulverized in a mortar, and the obtained powder was heat-treated at 1,100° C. for 2 hours. FIG. 5 shows the X-ray diffraction spectrum at this time. When the Rietveld analysis was performed based on the X-ray diffraction intensity, this powder was found to be a (Ba_{0.95}Ca_{0.05})(Ti_{0.8}Zr_{0.2})O₃ powder.

The specific surface area was 4.3 m²/g and according to formula (I), D1 was 0.23 μm. Also, D2 was 1.20 μm and thus, D2/D1 was found to be 5.2. Furthermore, d2/d1 as determined by the image analysis was 0.4, d3/d1 was 1.6 and d4/d1 was 1.9.

The dry powder was dissolved and the amount of K ion was measured by ICP spectrometry, as a result, 70 ppm of K ion was contained. Also, the amount of Cl ion was measured by anion chromatography, as a result, 100 ppm of Cl ion was contained.

### Comparative Example 1

A barium titanate zirconate powder was produced in the same manner as in Example 1, except for not adding TMAH but instead using 450 g of pure water. At this time, the pH of the reaction solution was 7.9.

The dry powder was pulverized in a mortar, and the obtained powder was heat-treated at 950° C. for 2 hours. This powder was found to be a Ba(Ti_{0.8}Zr_{0.2})O₃ powder in which barium carbonate in a large amount, titanium oxide and zirconium oxide were mixed.

### Comparative Example 2

A barium titanate zirconate powder was produced in the same manner as in Example 1, except for using 10 g of zirconium oxide (N—PC, produced by Nippon Denko Co., Ltd.) as the Zr compound.

The dry powder was pulverized in a mortar, and the obtained powder was heat-treated at 950° C. for 2 hours. This powder was found to be a Ba(Ti_{0.8}Zr_{0.2})O₃ powder in which barium carbonate in a large amount, titanium oxide and zirconium oxide were mixed.

### Comparative Example 3

A barium titanate zirconate powder was produced in the same manner as in Example 1, except for using 98 g of barium chloride dihydrate in place of charging 126.2 g of barium hydroxide octahydrate.

The dry powder was pulverized in a mortar, and the obtained powder was heat-treated at 950° C. for 2 hours. When the Rietveld analysis was performed based on the X-ray diffraction intensity, this powder was found to be a Ba(Ti_{0.8}Zr_{0.2})O₃ powder.

The specific surface area was 20 m²/g and according to formula (I), D1 was 0.050 μm. Also, D2 was 0.40 μm and thus, D2/D1 was found to be 8.0. Furthermore, d2/d1 as determined by the image analysis was 0.4, d3/d1 was 1.8 and d4/d1 was 2.2.

The dry powder was dissolved and the amount of K ion was measured by ICP spectrometry, as a result, 50 ppm of K ion was contained. Also, the amount of Cl ion was measured by anion chromatography, as a result, 60,000 ppm of Cl ion was contained.

### Comparative Example 4

A barium calcium titanate zirconate powder was produced in the same manner as in Example 1, except for using 450 g of an aqueous 20 mass % KOH solution in place of 450 g of an aqueous 20 mass % tetramethylammonium hydroxide solution.

The dry powder was pulverized in a mortar, and the obtained powder was heat-treated at 950° C. for 2 hours. When the Rietveld analysis was performed based on the X-ray diffraction intensity, this powder was found to be a Ba(Ti_{0.8}Zr_{0.2})O₃ powder.

The specific surface area was 19 m²/g and according to formula (I), D1 was 0.053 μm. Also, D2 was 0.45 μm and thus, D2/D1 was found to be 8.5. Furthermore, d2/d1 as determined by the image analysis was 0.2, d3/d1 was 1.9 and d4/d1 was 2.2.

The dry powder was dissolved and the amount of K ion was measured by ICP spectrometry, as a result, 70,000 ppm of K ion was contained. Also, the amount of Cl ion was measured by anion chromatography, as a result, 70 ppm of Cl ion was contained.

In this way, the titanium-containing perovskite composite oxide particles produced by the production processes of Examples 1 to 4 all were found to have a small particle diameter and be extremely reduced in the impurity amount of K (alkali metal) or chlorine (Cl) and assured of excellent properties, for example, as an electrode material of a capacitor. On the other hand, the titanium-containing perovskite composite oxide particles produced by the production processes of Comparative Examples 1 to 4 were a composite oxide in which titanium oxide and zirconium oxide were mixed (Comparative Examples 1 and 2) or the impurity amount of K (alkali metal) or chlorine (Cl) was large, and these composite oxides were found to be unsuitable as a material for electronic parts including a capacitor.

What is claimed is:

1. A titanium-containing perovskite composite oxide particle represented by the compositional formula: A(TiₓB₍₁₋ₓ₎)_{y}O₃ (provided that x and y each denoting a compositional ratio are 0<x<1 and 0.98≦y≦1.02, A is at least one or more element selected from Ca, Sr, Ba, Pb and Mg, and B is at least one or more element selected from Hf and Zr), wherein the specific surface area is from 1 to 100 m²/g, the average primary particle diameter D1 defined by formula (I) is from 10 to 1,000 nm, and the ratio D2/D1 of D1 to the average secondary particle diameter D2 is from 1 to 10:
D1=6/ρS (I)
(wherein ρ is a density of the particle and S is a specific surface area).

2. The titanium-containing perovskite composite oxide particle as described in claim 1, wherein assuming that the average particle diameter on the volume basis as determined by an image analysis method is d1, the particle diameter at 5% accumulated from the small particle diameter side is d2, the particle diameter at 95% accumulated from the small particle diameter side is d3 and the maximum particle diameter is d4, d2/d1 is from 0.1 to 1, d3/d1 is from 1 to 1.8 and d4/d1 is from 1 to 2.

3. The titanium-containing perovskite composite oxide particle as described in claim 1 or 2, wherein the alkali metal content is 100 ppm or less and the chlorine content is 600 ppm or less.

4. The titanium-containing perovskite composite oxide particle as described in claim 1, wherein A is Ba, B is Zr, and x denoting the compositional ratio is 0.4≦x<1.

5. The titanium-containing perovskite composite oxide particle as described in claim 1, wherein A comprises Ba and Ca, B is Zr, and x denoting the compositional ratio is 0.4≦x<1.

6. The titanium-containing perovskite composite oxide particle as described in claim 1, wherein A is Pb, B is Zr, and x denoting the compositional ratio is 0.3≦x≦0.7.

7. A process for producing the titanium-containing perovskite composite oxide particle described in claim 1, comprising a step of charging a metal salt containing at least one member selected from Ca, Sr, Ba, Pb and Mg, a particulate titanium oxide and a compound containing at least one member selected from Zr and Hf, in a basic compound-containing alkaline solution and reacting these components.

8. The production process of a titanium-containing perovskite composite oxide particle as described in claim 7, which comprises a step of removing the basic compound in the form of a gas after the reaction step.

9. The production process of a titanium-containing perovskite composite oxide particle as described in claim 7, wherein a heat treatment is performed at a temperature of 350 to 1,500° C. after the step of removing the basic compound.

10. The production process of a titanium-containing perovskite composite oxide particle as described in claim 7, wherein the particulate titanium oxide contains a brookite crystal.

11. The production process of a titanium-containing perovskite composite oxide particle as described in claim 7, wherein the particulate titanium oxide is a titanium oxide sol obtained by hydrolyzing a titanium compound in an acidic solution.

12. The production process of a titanium-containing perovskite composite oxide particle as described in claim 7, wherein the basic compound is a substance which vaporizes under atmospheric pressure or reduced pressure by at least one or more means selected from evaporation, sublimation and thermal decomposition.

13. The production process of a titanium-containing perovskite composite oxide particle as described in claim 7, wherein the basic compound is an organic base compound.

14. The production process of a titanium-containing perovskite composite oxide particle as described claim 7, wherein the basic compound is tetramethyl-ammonium hydroxide.

15. The production process of a titanium-containing perovskite composite oxide particle as described in claim 7, wherein the Zr or Hf compound is a water-soluble compound.

16. The production process of a titanium-containing perovskite composite oxide particle as described in claim 7, wherein the solubility of the Zr or Hf compound in water is 0.1 mass % or more in terms of ZrO₂ or HfO₂.

17. The production process of a titanium-containing perovskite composite oxide particle as described in claim 7, wherein the Zr compound is one or more compound selected from basic zirconium carbonate, zirconium acetate, zirconium nitrate, ammonium zirconium carbonate, zirconium sulfate and zirconium hydroxychloride.

18. A dielectric material comprising the titanium-containing perovskite composite oxide particle described in claim 1.

19. A paste comprising the titanium-containing perovskite composite oxide particle described in claim 1.

20. A slurry comprising the titanium-containing perovskite composite oxide particle described in claim 1.

21. A thin film-shaped product comprising the titanium-containing perovskite composite oxide particle described in claim 1.

22. A dielectric porcelain comprising the titanium-containing perovskite composite oxide particle described in claim 1.

23. A pyroelectric porcelain comprising the titanium-containing perovskite composite oxide particle described in claim 1.

24. A piezoelectric porcelain comprising the titanium-containing perovskite composite oxide particle described in claim 1.

25. A capacitor comprising the dielectric porcelain described in claim 22.

26. An electronic device comprising the thin film-shaped product described in claim 21.

27. A sensor comprising the thin film-shaped product described in claim 21.

28. A dielectric film comprising the titanium-containing perovskite composite oxide particle described in claim 1.

29. A capacitor produced by using the dielectric film described in claim 28.
